(19) United States
(12) Patent Application Publication
(10) Pub. No.: US 2021/0055790 A1
(43) Pub. Date: Feb. 25, 2021

(54) INFORMATION PROCESSING APPARATUS, INFORMATION PROCESSING SYSTEM, INFORMATION PROCESSING METHOD, AND RECORDING MEDIUM

(71) Applicants: Yuuki SUZUKI, Tokyo (JP); Kenichiroh SAISHO, Tokyo (JP); Hiroshi YAMAGUCHI, Tokyo (JP); Masato KUSANAGI, Tokyo (JP)

(72) Inventors: Yuuki SUZUKI, Kanagawa (JP); Kenichiroh SAISHO, Tokyo (JP); Hiroshi YAMAGUCHI, Kanagawa (JP); Masato KUSANAGI, Kanagawa (JP)

(21) Appl. No.: 16/979,012

(22) PCT Filed: Mar. 27, 2019
(86) PCT No.: PCT/JP2019/013266

§ 371 Date: Sep. 8, 2020

(30) Foreign Application Priority Data
Mar. 28, 2018 (JP) 2018-063049
Mar. 20, 2019 (JP) 2019-052961

(51) Int. Cl. G06F 3/01; G06F 3/0488; G06F 3/0482

(52) U.S. Cl. CPC G06F 3/013; G06F 3/0482; G06F 3/04883

(57) ABSTRACT

An information processing apparatus for displaying, on a display apparatus, a screen that includes items selectable by a user is provided. The information processing apparatus includes a display control unit configured to display, in response to detection of a predetermined motion of the user relative to an input apparatus when a first screen is displayed, a second screen based on a position at which the user is looking on the first screen, and a receiving unit configured to receive an input to the second screen, based on an operation performed by the user on the input apparatus. The objective is to allow a user to relatively readily perform an operation.

### TECHNICAL FIELD

The present invention relates to an information processing apparatus, an information processing system, a moving body, an information processing method, and a program.

### BACKGROUND ART

Conventionally, various human-computer interfaces such as switches, buttons, dials, touch panels, and touchpads are used in various electronic devices to receive operations from users. Further, a technology that uses the line of sight of a user when the user performs an operation is known (see Patent Document 1, for example).

### SUMMARY OF INVENTION

### Technical Problem

However, the conventional technology has a problem in that it is not relatively easy for a user to perform an operation because only one operation is performed at a time. In view of the above, it is an object of the present invention to provide a technology that allows a user to relatively readily perform an operation.

### Solution to Problem

An information processing apparatus for displaying, on a display apparatus, a screen that includes items selectable by a user is provided. The information processing apparatus includes a display control unit configured to display, in response to detection of a predetermined motion of the user relative to an input apparatus when a first screen is displayed, a second screen based on a position at which the user is looking on the first screen, and a receiving unit configured to receive an input to the second screen, based on an operation performed by the user on the input apparatus.

### Advantageous Effects of Invention

According to the technology disclosed herein, it becomes possible for a user to relatively readily perform an operation.

### BRIEF DESCRIPTION OF DRAWINGS

FIG. 1 is a diagram illustrating an example of a system configuration of an information processing system according to an embodiment;

FIG. 2 is a diagram illustrating an installation example (part 1) of the information processing system according to the embodiment;

FIG. 3 is a diagram illustrating an example of a hardware configuration of an information processing apparatus according to the embodiment;

FIG. 4 is a diagram illustrating an example of functional blocks of the information processing apparatus according to the embodiment;

FIG. 5 is a flowchart of an example of an operation support process according to the embodiment;

FIG. 6 is a flowchart of an example of an operation support process according to a first embodiment;

FIG. 7A is a diagram illustrating an example of a display screen according to the first embodiment;

FIG. 7B is a diagram illustrating an example of a display screen according to the first embodiment;

FIG. 7C is a diagram illustrating an example of a display screen according to the first embodiment;

FIG. 8A is a diagram illustrating an example of a display screen according to a second embodiment;

FIG. 8B is a diagram illustrating an example of a display screen according to the second embodiment;

FIG. 8C is a diagram illustrating an example of a display screen according to the second embodiment;

FIG. 8D is a diagram illustrating an example of a display screen according to the second embodiment;

FIG. 9A is a diagram illustrating an example of a system configuration of an information processing system according to an embodiment;

FIG. 9B is a diagram illustrating an example of an installation example (part 2) of the information processing system according to the embodiment; and

FIG. 10 is a diagram illustrating an example of a hardware configuration of a HUD according to the embodiment.

### DESCRIPTION OF EMBODIMENTS

In the following, embodiments of the present invention will be described with reference to the drawings.

### <System Configuration>

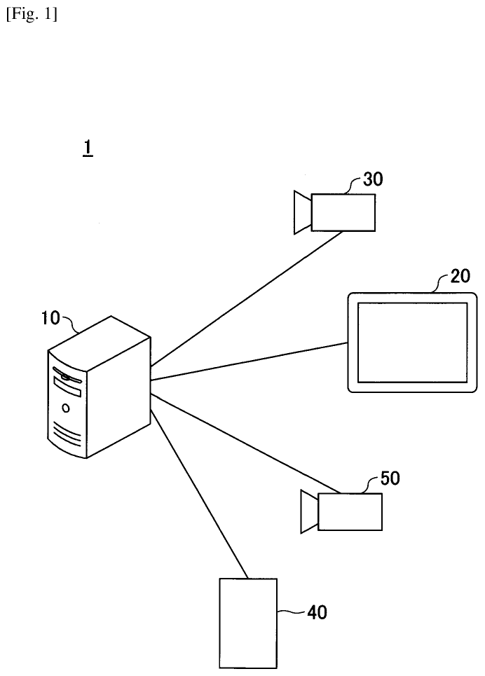

First, a system configuration of an information processing system 1 according to an embodiment will be described with reference to FIG. 1. FIG. 1 is a diagram illustrating an example of the system configuration of the information processing system 1 according to the embodiment. As illustrated in FIG. 1, the information processing system 1 according to the embodiment includes an information processing apparatus 10, a display apparatus 20, a line-of-sight sensor 30 (an example of a “first sensor”), an input apparatus 40, and a motion sensor 50 (an example of a “second sensor”). The information processing apparatus 10, the display apparatus 20, the line-of-sight sensor 30, the input apparatus 40, and the motion sensor 50 may be connected to each other via a cable, for example. Further, a plurality of devices of the information processing apparatus 10, the display apparatus 20, the line-of-sight sensor 30, the input apparatus 40, and the motion sensor 50 may be placed within the same housing so as to be integrally formed as one apparatus. For example, the input apparatus 40, which is, for example, a touch panel, and the display apparatus 20 may be integrally formed as one apparatus.

The information processing apparatus 10 is, for example, an information processing apparatus (electronic equipment or an electronic device) such as in-vehicle equipment, a notebook or desktop personal computer, television, or a portable or stationary game console. The information processing apparatus 10 displays, on the display apparatus 20, a screen that includes a menu of a plurality of items that can be selected by a user. Further, the information processing apparatus 10 performs a predetermined process in response to an operation by the user.

The display apparatus 20 is a display (a monitor) that displays a screen including a menu generated by the information processing apparatus 10.

The line-of-sight sensor 30 may be a small camera that detects the line-of-sight of a user based on the position of an iris relative to the inner corner of an eye. Further, the line-of-sight sensor 30 may be a device that includes an infrared LED and an infrared camera, and that irradiates the user's face with infrared rays and detects the line-of-sight of the user based on the position of the pupil relative to the position of corneal reflection.

The input apparatus 40 is an input apparatus such as, a touchpad, a touch panel, a switch, a button, a dial, or a controller. When the input apparatus 40 receives an operation from a user, the input apparatus 40 transmits information on the operation to the information processing apparatus 10.

The motion sensor 50 may be a depth sensor that detects the motion of a user, such as the motion of the user's hand moving towards the input apparatus 40, by using a camera and infrared rays to measure a distance from the input apparatus 40 to the user's hand. In addition, the motion sensor 50 may detect the movement of the user's arm, palm, and fingers.

In the following, an example in which the information processing system 1 is installed in a vehicle, a motorized bicycle, a non-motorized vehicle, or rolling stock will be described. It should be noted that the information processing system 1 may be installed in a moving object such as a vehicle, an aircraft, a ship, a personal mobility device, or an industrial robot, and may be installed in any equipment other than the moving body.

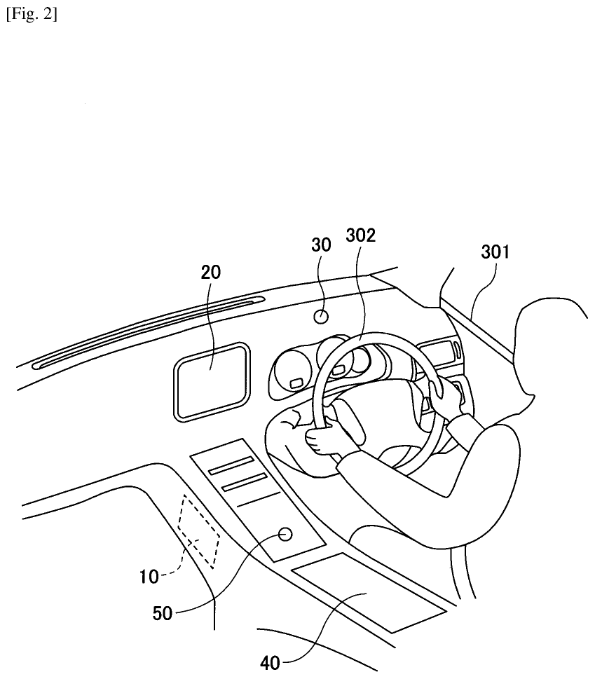

Next, an installation example of the information processing system 1 according to the embodiment will be described with reference to FIG. 2. FIG. 2 is a diagram illustrating an installation example (part 1) of the information processing system 1 according to the embodiment.

In the example illustrated in FIG. 2, the display apparatus 20 is a center display (a center panel) placed in the moving direction of the vehicle 301 when viewed from an occupant. The line-of-sight sensor 30 is placed behind a handle 302 when viewed from the occupant. The input apparatus 40 is placed on the left-hand side of the occupant. The motion sensor 50 is placed near the input apparatus 40. For example, the information processing apparatus 10 is placed in an inner part of the vehicle 301.

### <Hardware Configuration>

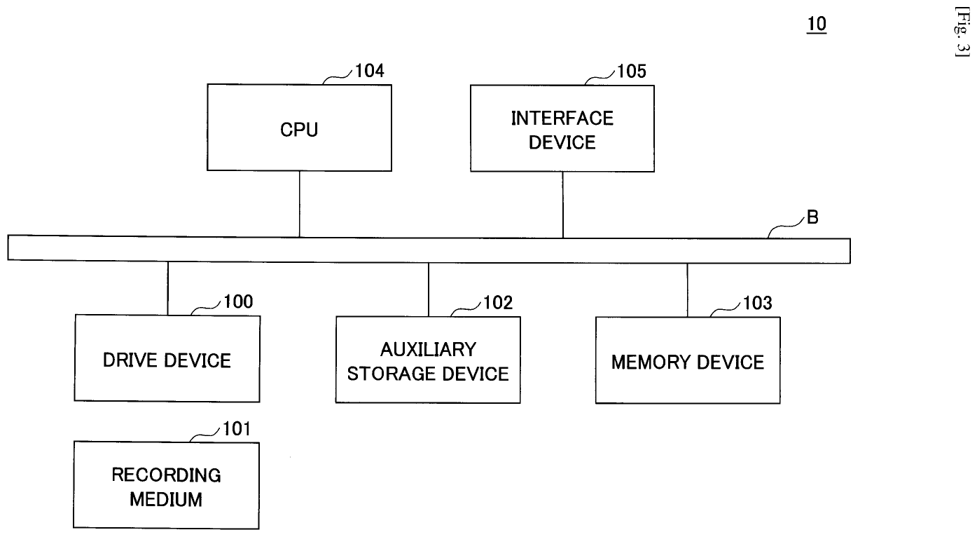

Next, a hardware configuration of the information processing apparatus 10 according to the present embodiment will be described with reference to FIG. 3. FIG. 3 is a diagram illustrating a hardware configuration of the information processing apparatus 10 according to the embodiment. As illustrated in FIG. 3, the information processing apparatus 10 according to the embodiment includes a drive device 100, an auxiliary storage device 102, a memory device 103, a CPU 104, and an interface device 105, which are connected to each other via a bus B.

A program for executing a process in the information processing apparatus 10 is provided by a recording medium 101. When the recording medium 101 storing the program is set in the drive device 100, the program is installed in the auxiliary storage device 102 from the recording medium 101 via the drive device 100. However, the program is not necessarily installed from the recording medium 101, and the program may be downloaded from another computer via a network. The auxiliary storage device 102 stores the installed program as well as necessary files and data. Examples of the recording medium 101 include a portable recording medium such as a CDROM, a DVD disc, or a universal serial bus (USB) memory. Further, examples of the auxiliary storage device 102 include a hard disk drive (HDD) and a flash memory. Each of the recording medium 101 and the auxiliary storage device 102 is equivalent to a computer-readable recording medium.

When an instruction to start a program is received, the memory device 103 reads the program from the auxiliary storage device 102 and stores the program. The CPU 104 implements functions of the information processing apparatus 10 in accordance with the program stored in the memory device 103. The interface device 105 may be an interface for communicating with an external controller and the like. For example, the interface device 105 may be connected to a vehicle navigation device and various types of other on-vehicle devices via, for example, a controller area network (CAN) of the vehicle 301.

### <Functional Configuration>

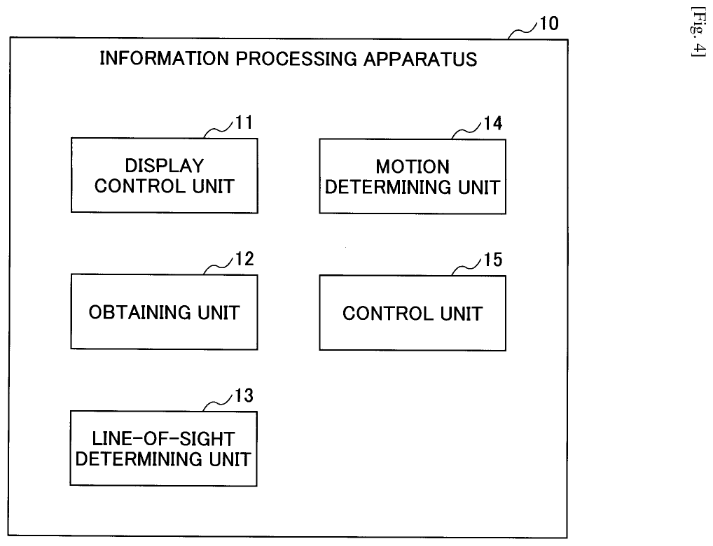

Next, a functional configuration of the information processing apparatus 10 according to the embodiment will be described with reference to FIG. 4. FIG. 4 is a diagram illustrating an example of functional blocks of the information processing apparatus 10 according to the embodiment.

The information processing apparatus 10 includes a display control unit 11, an obtaining unit 12, a line-of-sight determining unit 13, a motion determining unit 14, and a control unit 15 (an example of “receiving unit”). These functional units are implemented by processes that one or more programs installed on the information processing apparatus 10 cause the CPU 104 to execute.

The obtaining unit 12 obtains information indicating a direction of the user's line of sight (a position at which the user is looking) from the line-of-sight sensor 30. In addition, the obtaining unit 12 obtains information indicating the user's motion from the motion sensor 50.

Based on the information indicating the direction of the user's line of sight obtained from the line-of-sight sensor 30, the line-of-sight determining unit 13 determines coordinates, which correspond to pixels, of a position at which the user is looking on a screen of the display apparatus 20.

The motion determining unit 14 detects a predetermined motion of at least a part of the user's body, based on the information indicating the user's motion obtained from the motion sensor 50.

When the predetermined motion of the user relative to the input apparatus 40 is detected by the motion determining unit 14 while a first screen is displayed, the display control unit 11 displays a second screen based on a position at which the user is looking on the first screen. The second screen may be a detail screen that displays detailed items related to information that is displayed on the position at which the user is looking on the first screen, or may be a detail screen that displays details of information that is displayed on the position at which the user is looking on the first screen.

### <Processing>

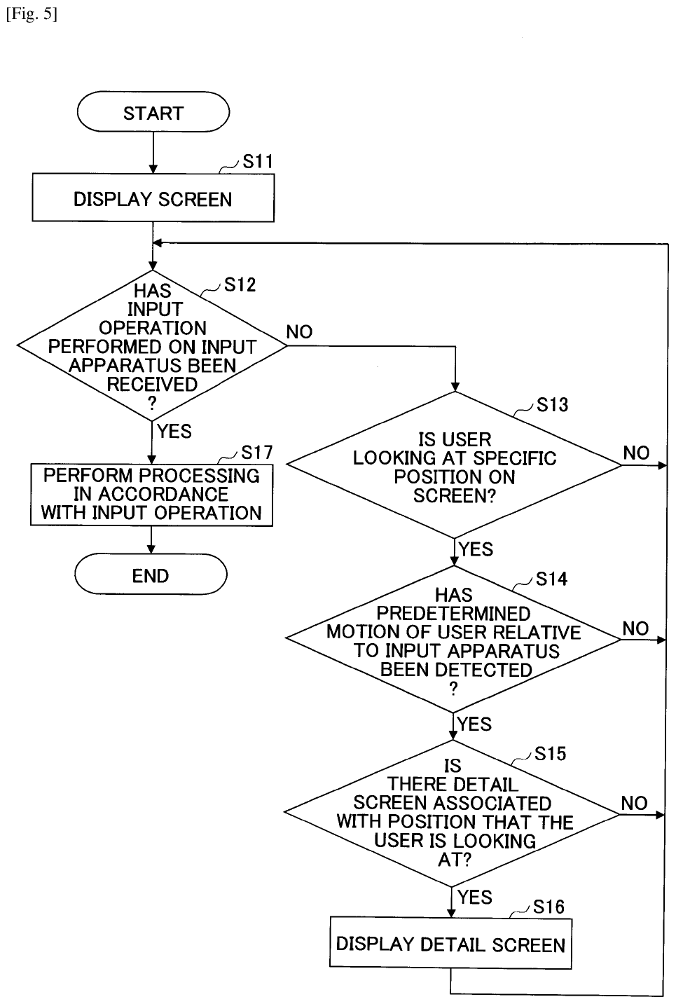

Next, referring to FIG. 5, an operation support process performed by the information processing apparatus 10 according to the embodiment will be described.

FIG. 5 is a flowchart of an example of the operation support process performed by the information processing apparatus 10 according to the embodiment. In step S11, the display control unit 11 displays, on the display apparatus 20, a screen for allowing a user to perform an operation. In step S12, the display control unit 11 determines whether an input operation is performed on the input apparatus 40. When an input operation is performed (yes in step S12), processing is performed in accordance with the input operation (step S17), and the process ends.

When no input operation is performed (no in step S12), the line-of-sight determining unit 13 determines whether the user is looking at a specific position on the screen of the display apparatus 20 in step S13. When the line-of-sight determining unit 13 determines that the user is looking at a specific position (yes in step S13), the motion determining unit 14 determines whether a predetermined motion of at least a part of the user's body relative to the input apparatus 40 has been detected in step S14. When a predetermined motion of at least a part of the user's body relative to the input apparatus 40 has not been detected (no in step S14), the process returns to step S12.

When a predetermined motion of at least a part of the user's body relative to the input apparatus 40 has been detected (yes in step S14), the display control unit 11 determines whether there is a detail screen associated with the position that the user is looking at in step S15. When there is no detail screen (no in step S15), the process returns to step S12. When there is a detail screen (yes in step S15), the display control unit 11 displays the detail screen on the display apparatus 20.

As will be described later, the predetermined motion detected in step S14 is not necessarily the same motion every time. The predetermined motion may change in accordance with the contents of a detail screen each time a detail screen is displayed. Details will be described later.

### First Embodiment

A first embodiment of the present invention will be described below. In the first embodiment, a hierarchical menu is displayed. Functions of the display control unit 11 according to the first embodiment will be described.

In the present embodiment, for example, in a hierarchical menu, when an item is selected from a plurality of items that can be selected by the user, the display control unit 11 displays, on the display apparatus 20, a screen that includes a menu of a plurality of items associated with the selected item.

More specifically, when a predetermined motion is detected by the motion determining unit 14, the display control unit 11 displays, on the display apparatus 20, a screen (an example of the “detail screen”) that includes a menu one level lower in the hierarchy than the item, which has been determined by the line-of-sight determining unit 13 that the user is looking at, among the plurality of items.

The control unit 15 receives, from the input apparatus 40, an operation performed by the user with respect to the one-level lower menu displayed on the screen (the example of the “detail screen”) by the display control unit 11.

### <Processing>

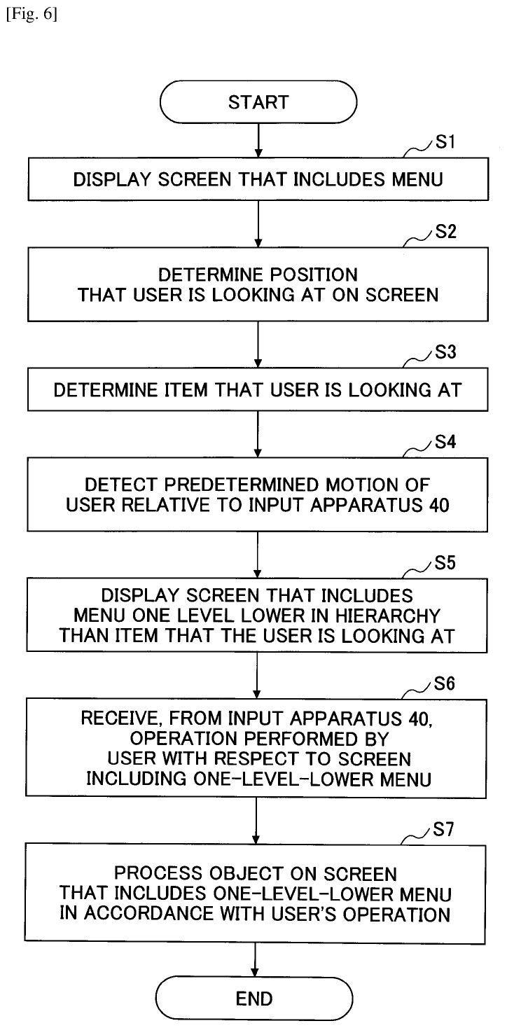

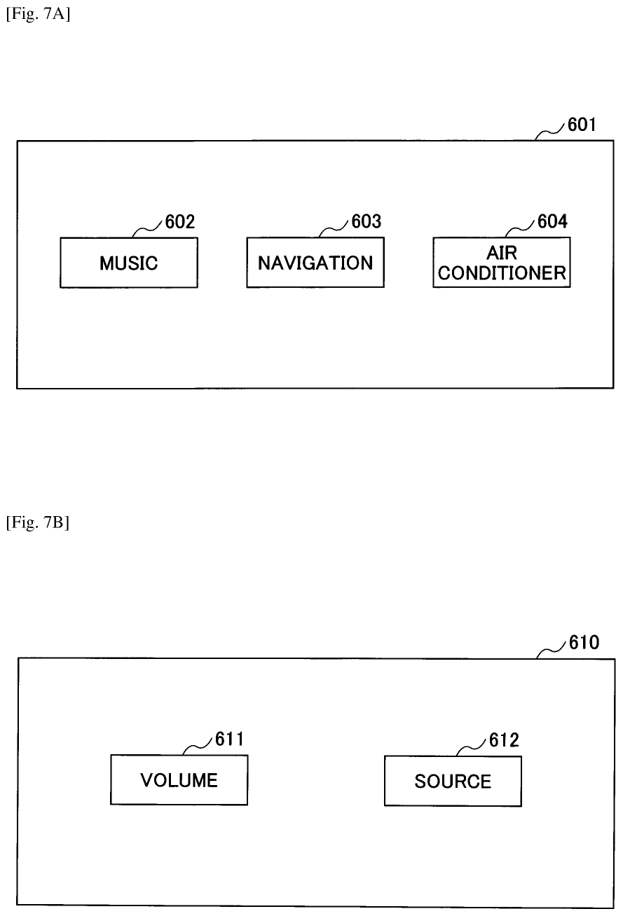

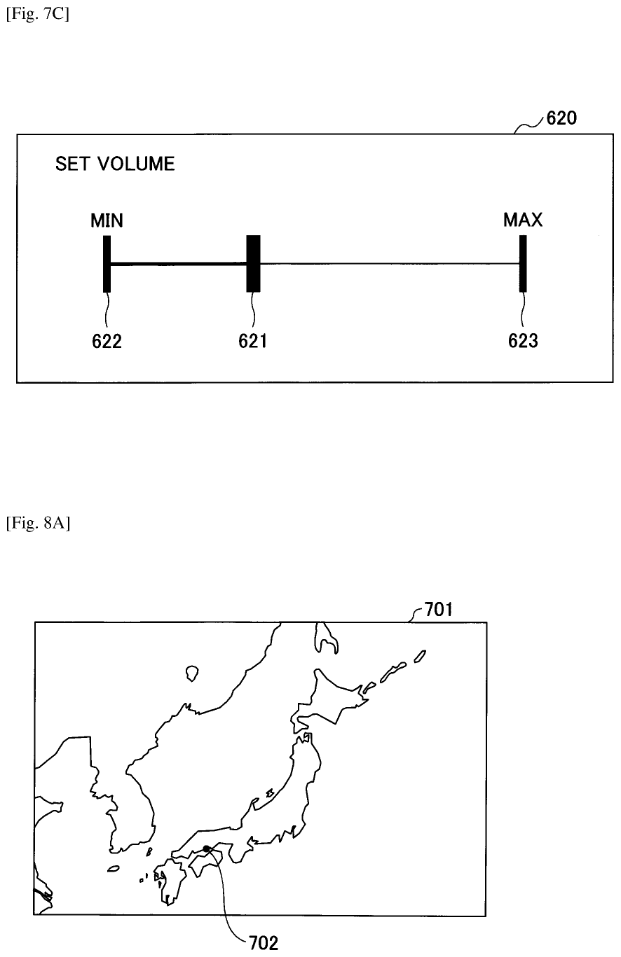

Next, referring to FIG. 6 and FIGS. 7A through 7C, an operation support process performed by the information processing apparatus 10 according to the present embodiment will be described. FIG. 6 is a flowchart of an example of the operation support process according to the present embodiment. FIGS. 7A through 7C are diagrams illustrating examples of display screens according to the embodiment.

In step S1, the display control unit 11 displays, on the display apparatus 20, a screen that includes a menu of a plurality of items that can be selected by a user. For example, the display control unit 11 may display a screen that includes a menu illustrated in FIG. 7A. In the example of FIG. 7A, a “music” button 602, a “navigation” button 603, and an “air conditioner” button 604 are displayed on a display screen 601.

Next, the line-of-sight determining unit 13 determines a position at which the user is looking on the screen of the display apparatus 20 (step S2). For example, the line-of-sight determining unit 13 determines coordinates, which correspond to pixels, of a position at which the user is looking on the screen of the display apparatus 20 based on information indicating a direction of the user's line of sight obtained by the obtaining unit 12 from the line-of-sight sensor 30 and based on preliminarily set information on the position of the user's eye relative to the position of the display apparatus 20. For example, the line-of-sight determining unit 13 may determine, as a position that the user is looking at, an area where the line of sight is maintained for the longest period time within a predetermined period of time.

Next, the display control unit 11 determines, from the plurality of items in the currently displayed menu, an item (an object) that the user is looking at on the screen (step S3). More specifically, the display control unit 11 determines an object such as a button displayed at the position, which has been determined by the line-of-sight determining unit 13 that the user is looking at on the screen of the display apparatus 20.

Next, the motion determining unit 14 detects a predetermined motion of at least a part of the user's body relative to the input apparatus 40 (step S4). More specifically, the motion determining unit 14 detects the motion of the user's hand (an example of “at least the part of the user's body”) moving towards the input apparatus 40, based on information indicating the motion of the user obtained by the obtaining unit 12 from the motion sensor 50 and based on information on preliminarily set position information of the input apparatus 40. For example, based on information indicating the motion of the user obtained by the obtaining unit 12 from the motion sensor 50, the motion determining unit 14 may detect, as the predetermined motion, a gesture of the user's index finger moving towards the right direction, for example.

Next, the display control unit 11 displays, on the display apparatus 20, a screen (an example of the “detail screen”) that includes a menu (submenu) one level lower in the hierarchy than the item, which has been determined that the user is looking at (step S5). Further, by continuously repeating steps S2 through S5 at multiple times, it is possible to transition to menus on two or more lower levels.

For example, on the screen displaying the menu illustrated in FIG. 7A, when the user moves the hand towards the input apparatus 40 while looking at the “music” button 602, and a distance between the input apparatus 40 and the user's hand becomes equal to a distance (an example of a “first distance”) that is less than a first threshold and is greater than or equal to a second threshold, which is lower than the first threshold, the display control unit 11 may display a screen that includes a submenu illustrated in FIG. 7B. In the example of FIG. 7B, a “volume” button 611 and a “source” button 612 are displayed on a display screen 610, as a menu that is one level lower in the hierarchy (an example of a “first level of hierarchy”) than the “music” item.

Further, on the screen displaying the menu illustrated in FIG. 7B, when the user moves the hand towards the input apparatus 40 while looking at the “volume” button 611, and a distance between the input apparatus 40 and the user's hand becomes equal to a distance (an example of a “second distance”) that is less than the second threshold, the display control unit 11 may display a screen that includes a submenu illustrated in FIG. 7C. In the example of FIG. 7C, a slide bar 621 for adjusting the volume, a minimum value 622 of the volume, and a maximum value 623 of the volume are displayed on a display screen 620, as a menu that is one level lower in the hierarchy (an example of a “second level”) than the “volume” item of FIG. 7B.

Accordingly, for example, when the user desires to adjust the volume of music, a display screen for operating a menu at a desired level of a hierarchy can be displayed by moving the hand towards the input apparatus 40 only at one time. Thus, an operation for displaying a menu at the desired level of the hierarchy can be omitted (skipped). Accordingly, when the user actually operates the input apparatus 40, the user can immediately operate the menu at the desired level of the hierarchy.

It should be noted that, in a case where a predetermined gesture of the user is detected by the motion determining unit 14 while a screen that includes a menu at a predetermined level of a hierarchy is displayed, the display control unit 11 may display a screen that includes a menu (at the original level) that is one level upper than the predetermined level of the hierarchy. In this case, in a case where a gesture of the user's finger moving in a predetermined direction is detected by the motion determining unit 14, the display control unit 11 may return to the screen that includes the menu at the original level. Accordingly, when an item, which has been determined that the user is looking at by the line of sight detection, was not an item that the user desires to operate, the display control unit 11 can relatively readily return to the screen that includes the menu at the original level of the hierarchy.

Further, in a case where the user has not looked at the screen, which includes the menu at the predetermined level of the hierarchy, for a predetermined period of time while the above screen is displayed, the display control unit 11 may display a screen that includes a menu (at the original level) one level upper than the predetermined level. In this case, when the line-of-sight determining unit 13 determines that the user has not looked at the screen of the display apparatus 20 for a predetermined period of time, the display control unit 11 returns to the screen that includes the menu at the original level.

Accordingly, when the item, which has been determined as an operation target by the line-of-sight detection, was not an item that the user desires to operate, it is possible to relatively readily return to the screen that includes the menu at the original level of the hierarchy.

Next, the control unit 15 receives, from the input apparatus 40, an operation performed by the user with respect to the screen (the example of the “detail screen”) including the one-level-lower menu (step S6). Next, the control unit 15 processes the object on the screen that includes the one-level-lower menu in accordance with the user's operation (step S7), and causes the operation support process to end. Specifically, when the input apparatus 40 is a touchpad, the control unit 15 moves the slide bar 621 for adjusting the volume between the minimum value 622 and the maximum value 623 of the volume, in response to an operation of the user sliding the finger on the touchpad. Then, the control unit 15 controls the sound output of the music at the volume adjusted by using the slide bar 621.

### <Summary of First Embodiment>

In the conventional technology, in order for a user to display and operate a specific item in a hierarchical menu, the user would need to perform selection operations repeatedly by the number of times corresponding to the number of levels in the hierarchy from the currently displayed item to the specific item. For example, in the technology, if an item is selected after the user's line of sight is maintained on the item for a predetermined period of time, the user would need to gaze at an item for the predetermined period of time, every time an item is selected. Thus, it may be difficult for the user to perform an operation.

According to the above-described embodiment, in response to detection of the predetermined motion of the user relative to the input apparatus, a detail screen associated with an item that the user is looking at is displayed. Accordingly, it becomes relatively easy for the user to perform an operation.

### Second Embodiment

A second embodiment of the present embodiment will be described. In the second embodiment, an example of displaying a detail screen such that a user can readily make a selection will be described.

### <Example of Selecting Destination on Map>

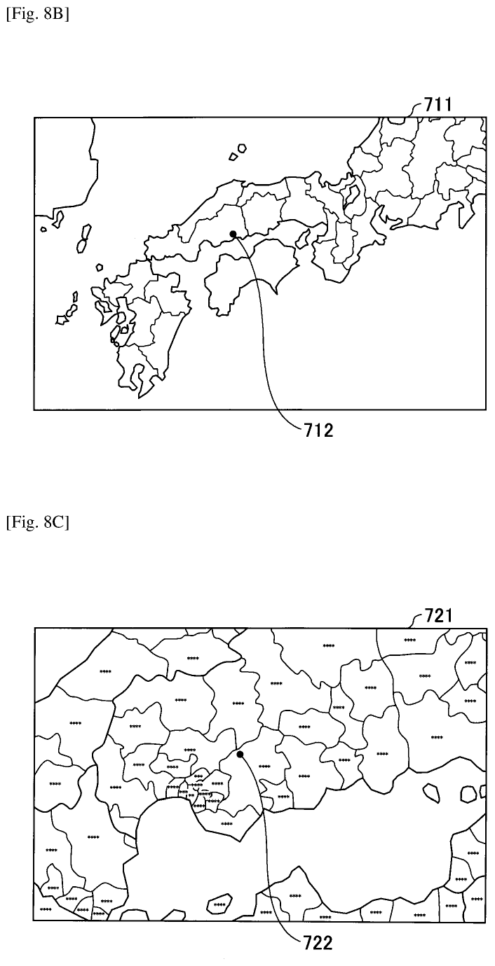

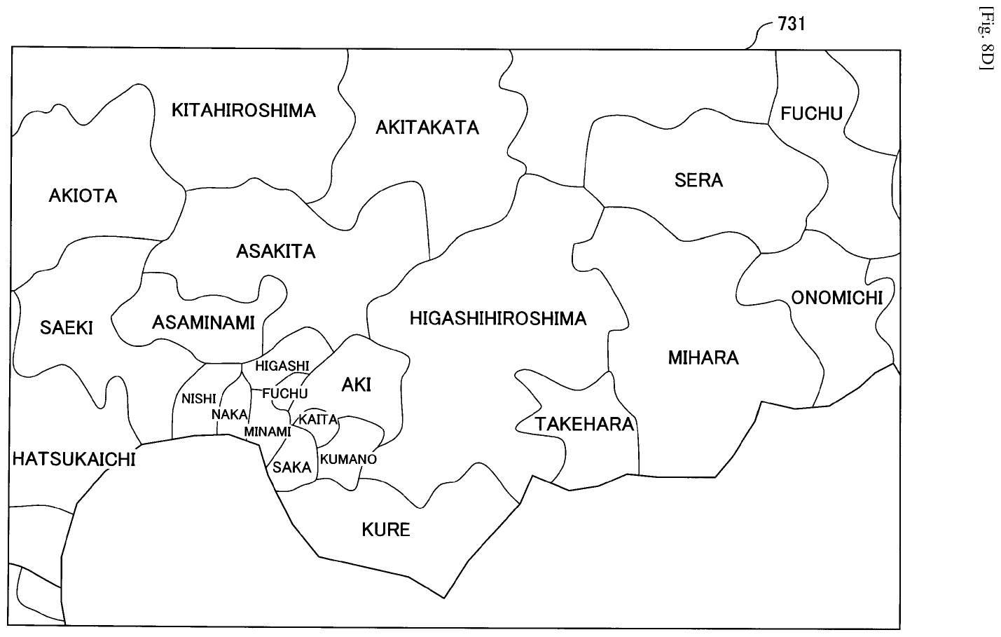

In the second embodiment, an example of selecting a destination on a map will be described with reference to FIGS. 8A through 8D. FIGS. 8A through 8D are diagrams illustrating examples of display screens according to the second embodiment. In step 12 through S16 of FIG. 5, the display control unit 11 displays a large-scale map of Japan on a display screen 701, as illustrated in FIG. 8A.

It is assumed that the user moves the hand towards the input apparatus 40 while looking at an item 702, which is a position on the map, on the display screen 701, and a distance between the input apparatus 40 and the user's hand becomes equal to a distance (an example of the “first distance”) that is less than a third threshold and is greater than or equal to a fourth threshold. In this case, as a detail screen associated with the item 702 illustrated in FIG. 8A, the display control unit 11 displays a map with more detail (an example of the “detail screen”) than the map of FIG. 8A, with the item 702, which is a position on the map, being the center of the map. It should be noted that, although map images are switched in FIG. 8A and FIG. 8B, a screen displaying an enlarged image of at least a part of the map image of FIG. 8A may be displayed as the map (the detail screen) with more detail than FIG. 8A.

Subsequently, it is assumed that the user further moves the hand towards the input apparatus 40 while looking at an item 712, which is a position on the map, on the display screen 711, and a distance between the input apparatus 40 and the user's hand becomes equal to a distance (an example of the “second distance”) that is less than the fourth threshold and is greater than or equal to a fifth threshold, which is lower than the fourth threshold. In this case, as a detail screen associated with the item 712 illustrated in FIG. 8B, the display control unit 11 displays a map with more detail than the map of FIG. 8B on a display screen 721, with the item 712, which is a position on the map, being the center of the map. It should be noted that, although map images are switched in FIG. 8B and FIG. 8C, a screen displaying an enlarged image of at least a part of the map image of FIG. 8B may be displayed as the map (the detail screen) with more detail than FIG. 8B.

Subsequently, it is assumed that the user further moves the hand towards the input apparatus 40 while looking at an item 722, which is a position on the map, on the display screen 721, and a distance between the input apparatus 40 and the user's hand becomes equal to a distance that is less than a fifth threshold and is greater than or equal to a sixth threshold, which is lower than the fifth threshold. In this case, as a detail screen associated with the item 722 illustrated in FIG. 8C, the display control unit 11 displays a map with more detail than the map of FIG. 8C on a display screen 731, with the item 722 being the center of the map. It should be noted that, although map images are switched in FIG. 8C and FIG. 8D, a screen displaying an enlarged image of at least a part of the map image of FIG. 8C may be displayed as the map (the detail screen) with more detail than FIG. 8C.

Accordingly, for example, when the user desires to set a destination, a detail screen for allowing the user to readily make a selection can be displayed by moving the hand towards the input apparatus 40 only at one time. Thus, an operation for selecting a detail screen can be omitted (skipped). Accordingly, when the user actually operates the input apparatus 40, the user can immediately operate the detail screen.

Then, in steps S12 through S17 of FIG. 5, when the user performs an operation for touching the touchpad, which is the input apparatus 40, while looking at the specific position on the display screen 721 of FIG. 8C, the control unit 15 sets the specific position as a destination, and starts navigation for a route from the current location of the vehicle 301 to the destination.

### <Summary of Second Embodiment>

In the conventional technology, in order for a user to display and operate a specific item in a hierarchical menu, the user would need to repeatedly enlarge the specific item from the currently displayed screen to a screen on which the specific item can be selected. For example, in the technology, if an item is selected after the user's line of sight is maintained on the item for a predetermined period of time, the user would need to gaze at an item for the predetermined period of time, every time an item is selected. Thus, it may be difficult for the user to perform an operation.

According to the above-described embodiment, in response to detection of the predetermined motion of the user relative to the input apparatus, a detail screen associated with an item that the user is looking at is displayed. Accordingly, it becomes relatively easy for the user to perform an operation.

### <Variation>

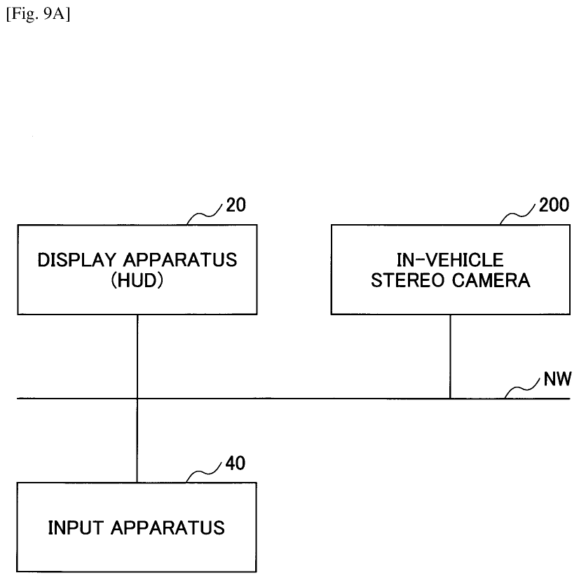

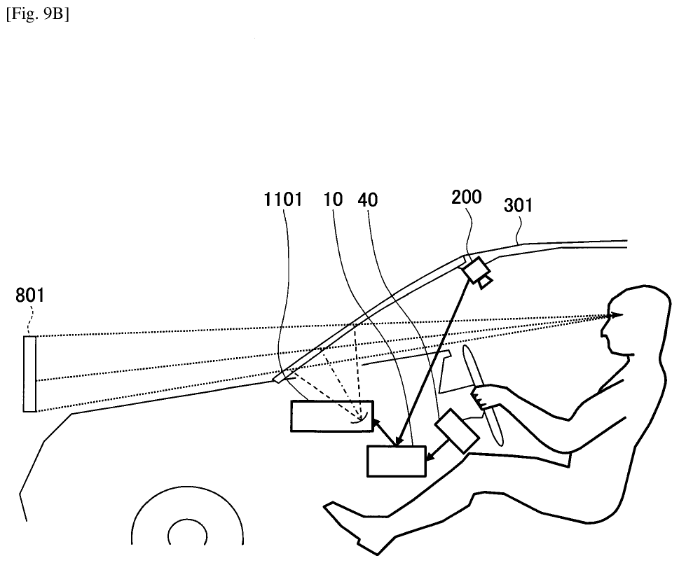

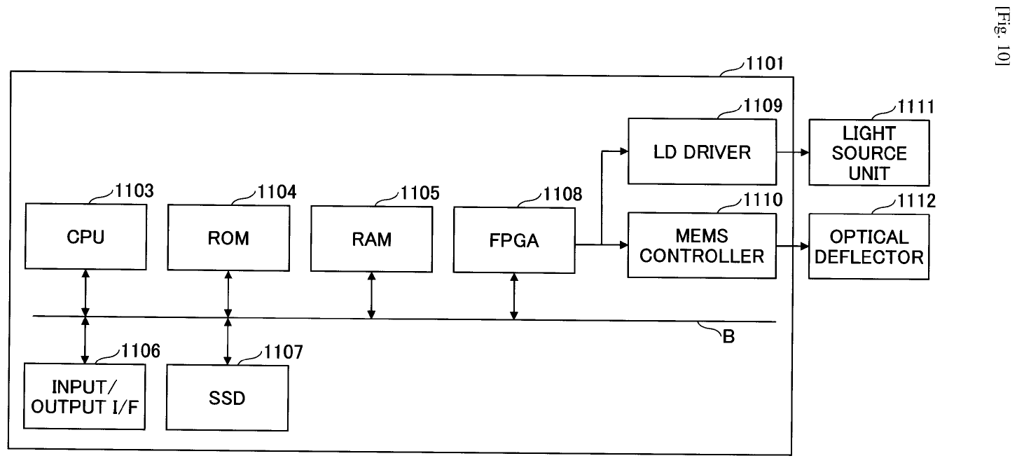

Next, an installation example (part 2) of an information processing system 1 according to an embodiment will be described with reference to FIGS. 9A and 9B. FIG. 9A is a diagram illustrating an example of a system configuration of the information processing system 1 according to the embodiment. FIG. 9B is a diagram illustrating an example of an installation example of the information processing system 1 according to the embodiment.

In the example of FIG. 9A, the information processing system 1 includes the display apparatus 20, an in-vehicle stereo camera 200, and the input apparatus 40. The in-vehicle stereo camera 200 is an example of one sensor that includes functions of both the line-of-sight sensor 30 and the motion sensor 50. The display apparatus 20, the in-vehicle stereo camera 200, the information processing apparatus 10, and the input apparatus 40 may be connected to each other via an in-vehicle network (NW) such as a controller area network (CAN) bus, for example.

In the example of FIG. 9A, the display apparatus 20 is a head-up display (HUD) for making a virtual image 801 visible to a user.

### <<Hardware Configuration of HUD>>

Next, referring to FIG. 10, a hardware configuration of the HUD will be described. FIG. 10 is an example of the hardware configuration of the HUD according to the embodiment.

A processor 1101 of the HUD includes a central processing unit (CPU) 1103, a read-only memory (ROM) 1104, a random-access memory (RAM) 1105, an input/output interface (I/F) 1106, a solid state drive (SSD) 1107, a field-programmable gate array (FPGA) 1108, a LD driver 1109, and a MEMS controller 1110, which are connected to each other via a bus B.

The CPU 1103 is an arithmetic device that controls the entire processor 1101 by reading programs and data from storage devices, such as the ROM 1104 and the SSD 1107, into the RAM 1105, and executing processes. It should be noted that a part of or the entirety of functions of the CPU 1103 may be implemented by hardware such as an application-specific integrated circuit (ASIC) or a FPGA.

The ROM 1104 is a non-volatile semiconductor memory (a storage device) that can retain programs and data even when the power is turned off. The ROM 1104 stores programs and data.

The RAM 1105 is a volatile semiconductor memory (a storage device) that temporarily stores programs and data. The RAM 1105 includes an image memory that temporarily stores image data in order for the CPU 1103 to execute processing such as image processing.

The SSD 1107 is a non-volatile storage device that stores programs and data. Instead of the SSD 1107, a hard disk drive (HDD) or the like may be provided.

The input/output I/F 1106 is an interface for connecting to external equipment. In addition, the processor 1101 may be connected to the in-vehicle network such as the CAN bus via the input/output I/F 1106.

The FPGA 1108 controls the LD driver 1109 based on an image created by the CPU 1103. The LD driver 1109 is electrically connected to a light source unit 1111, and drives LDs of a light source unit 1111 to control emission of light from the LDs in accordance with the image.

The FPGA 1108 causes the MEMS controller 1110, which is electrically connected to an optical deflector 1112, to operate the optical deflector 1112 such that a laser beam is deflected in a direction in accordance with the pixel position of the image.

### <Other>

The functional units of the information processing apparatus 10 may be implemented by cloud computing configured by one or more computers. Further, the information processing apparatus 10 may be configured such that at least one functional unit of the functional units may be included in an apparatus separately from an apparatus that includes the other functional units. In this case, for example, the control unit 15 may be included in any other electronic device. Further, the line-of-sight determining unit 13 and the motion determining unit 14 may be included in a server apparatus in the cloud. Namely, the information processing apparatus 10 may be configured by a plurality of apparatuses.

Further, the functional units of the information processing apparatus 10 may be implemented by hardware such as an application-specific integrated circuit (ASIC), for example.

Although the embodiments of the present invention have been specifically described above, the present invention is not limited to the specific embodiments, and various variations and modifications may be made without departing from the scope of the present invention described in the claims.

The present application is based on Japanese priority application No. 2018-063049, filed on Mar. 28, 2018, and Japanese priority application No. 2019-052961, filed on Mar. 20, 2019, with the Japanese Patent Office, the entire content of which is hereby incorporated by reference.

### REFERENCE SIGNS LIST

1 information processing system
10 information processing apparatus
11 display control unit
12 obtaining unit
13 line-of-sight determining unit
14 motion determining unit
15 control unit
20 display apparatus
30 line of sight sensor
40 input apparatus
50 motion sensor
301 vehicle

### CITATION LIST

### Patent Literature

[NPL 1] Japanese Unexamined Patent Application Publication No. 2018-105854

1. An information processing apparatus for displaying, on a display apparatus, a screen that includes items selectable by a user, the information processing apparatus comprising:
a display control unit configured to display, in response to detection of a predetermined motion of the user relative to an input apparatus when a first screen is displayed, a second screen based on a position at which the user is looking on the first screen; and
a receiving unit configured to receive an input to the second screen, based on an operation performed by the user on the input apparatus.

2. The information processing apparatus according to claim 1, wherein the predetermined motion is a motion of at least a part of the user's body moving towards the input apparatus.

3. The information processing apparatus according to claim 2, wherein the display control unit displays the first screen when a distance between the at least the part of the user's body and the input apparatus is equal to a first distance, and displays the second screen when the distance between the at least the part of the user's body and the input apparatus is equal to a second distance that is closer than the first distance.

4. The information processing apparatus according to claim 1, wherein the display control unit displays the first screen in response to a predetermined gesture being performed by the user when the second screen is displayed.

5. The information processing apparatus according to claim 1, wherein the display control unit displays the first screen in a case where the user has not looked at the second screen for a predetermined period of time when the second screen is displayed.

6. An information processing system for displaying, on a display apparatus, a screen that includes items selectable by a user, the information processing system comprising:
a first sensor configured to at least detect a position at which the user is looking;
a display control unit configured to display in response to detection of a predetermined motion of the user relative to an input apparatus when a first screen is displayed, a second screen in accordance with the position at which the user is looking, the position being detected by the first sensor, and
a receiving unit configured to receive an input to the second screen, based on an operation performed by the user on the input apparatus.

7. A moving body comprising:
the information processing system according to claim 6; the display apparatus; and the input apparatus.

8. An information processing method performed by an information processing apparatus for displaying, on a display apparatus, a screen that includes items selectable by a user, the method comprising:
displaying, in response to detection of a predetermined motion of the user relative to an input apparatus when a first screen is displayed, a second screen based on a position at which the user is looking on the first screen; and
receiving an input to the second screen, based on an operation performed by the user on the input apparatus.

9. A non-transitory computer-readable recording medium storing a program for causing an information processing apparatus to display, on a display apparatus, a screen that includes items selectable by a user to execute a process comprising:
displaying, in response to detection of a predetermined motion of the user relative to an input apparatus when a first screen is displayed, a second screen based on a position at which the user is looking on the first screen; and
receiving an input to the second screen, based on an operation performed by the user on the input apparatus.
